(19) United States
(12) Patent Application Publication
(10) Pub. No.: US 2014/0061023 A1
(43) Pub. Date: Mar. 6, 2014

(54) TREATMENT APPARATUS AND TREATMENT METHOD

(71) Applicant: Kabushiki Kaisha Toshiba, Minato-ku (JP)

(72) Inventors: Hideaki HIRABAYASHI, Kanagawa-ken (JP); Naoaki Sakurai, Kanagawa-ken (JP); Naoya Hayamizu, Kanagawa-ken (JP)

(73) Assignee: Kabushiki Kaisha Toshiba, Minato-ku (JP)

(21) Appl. No.: 14/010,904

(22) Filed: Aug. 27, 2013

(30) Foreign Application Priority Data
Sep. 4, 2012 (JP) 2012-194277

(51) Int. Cl. C02F 5/00

(52) U.S. Cl. CPC C02F 5/00
USPC 203/7; 210/206; 210/192; 210/177; 210/149; 210/758; 210/748.17; 202/176

(57) ABSTRACT

According to one embodiment, a treatment apparatus includes a treatment liquid storage unit and a supply unit. The treatment liquid storage unit is configured to store a treatment liquid containing an acid and an oxidizing substance. The supply unit is configured to supply the treatment liquid stored in the treatment liquid storage unit to a fluid extracted via a production well.

### CROSS-REFERENCE TO RELATED APPLICATIONS

This application is based upon and claims the benefit of priority from Japanese Patent Application No. 2012-194277, filed on Sep. 4, 2012; the entire contents of which are incorporated herein by reference.

### FIELD

Embodiments described herein relate generally to a treatment apparatus and the treatment method.

### BACKGROUND

As the scheme of the geothermal electricity generation system, there are a dry steam system, a flash cycle system, a binary cycle system, etc. In the steam and the hot water extracted via a production well used for the geothermal electricity generation system, magnesium, calcium, manganese, silicon, and the like are dissolved. If these components dissolved in the steam and the hot water are deposited and attached to the interior of a pipe, an evaporator, etc. as a scale, power generation efficiency may be reduced. In the case of the binary cycle system, since hot water with a relatively low temperature is used, those components dissolved in the hot water are likely to be deposited.

Hence, a technique is proposed in which an acid is added to hot water to suppress the deposition of those components dissolved in the hot water.

However, when an acid is simply added, components such as a pipe formed with iron may be corroded.

### BRIEF DESCRIPTION OF THE DRAWINGS

FIG. 1 is a schematic diagram for illustrating a geothermal electricity generation system 100 including a treatment apparatus 1 according to a first embodiment;

FIG. 2 is the potential-pH diagram (Pourbaix diagram) of iron;

FIG. 3 is the potential-pH diagram of magnesium;

FIG. 4 is the potential-pH diagram of calcium;

FIG. 5 is the potential-pH diagram of manganese;

FIG. 6 is the potential-pH diagram for illustrating a region where the corrosion of components formed with iron can be suppressed and also the attachment of a scale can be suppressed;

FIG. 7 is the potential-pH diagram of silicon;

FIG. 8 is a graph for illustrating relationships among the temperature of the fluid, the pH value of the fluid, and the deposition of silicon; and

FIG. 9 is a schematic diagram for illustrating a treatment apparatus 10 according to a second embodiment.

### DETAILED DESCRIPTION

In general, according to one embodiment, a treatment apparatus includes a treatment liquid storage unit and a supply unit. The treatment liquid storage unit is configured to store a treatment liquid containing an acid and an oxidizing substance. The supply unit is configured to supply the treatment liquid stored in the treatment liquid storage unit to a fluid extracted via a production well.

Hereinbelow, embodiments are described with reference to the drawings. In the drawings, like components are marked with the same reference numerals, and a detailed description is omitted as appropriate.

As described above, there are a dry steam system, a flash cycle system, a binary cycle system, etc. as the scheme of the geothermal electricity generation system; the treatment apparatus and the treatment method according to the embodiment can be used for various geothermal electricity generation systems.

Herein, a treatment apparatus and a treatment method used for a binary cycle-type geothermal electricity generation system are illustrated as an example.

### First Embodiment

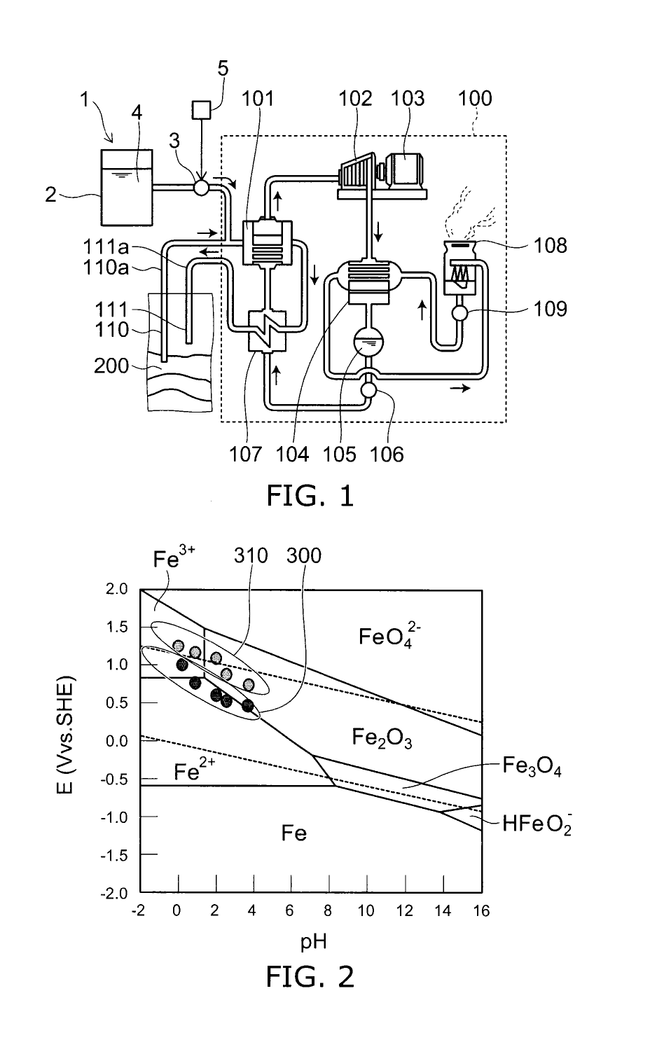

FIG. 1 is a schematic diagram for illustrating a geothermal electricity generation system 100 including a treatment apparatus 1 according to a first embodiment.

As shown in FIG. 1, an evaporator 101, a turbine 102, an electric generator 103, a condenser 104, a hot well tank 105, a pump 106, a preheater 107, a cooling tower 108, and a pump 109 are provided in the geothermal electricity generation system 100.

A production well 110 and a reduction well 111 provided by excavating a stratum 200 are connected to the evaporator 101 via pipes 110a and 111a, respectively. The production well 110 is a borehole for recovering a fluid (e.g. hot water and steam) heated by subterranean heat to above the ground. The reduction well 111 is a borehole for returning the fluid after used to evaporate a medium in the evaporator 101 to below the ground.

The evaporator 101 heats and evaporates the medium using the heat of the fluid extracted via the production well 110.

The medium may be a fluid with a lower boiling point than water. The medium may be, for example, ammonia, a CFC, isopentane, or the like.

The medium evaporated in the evaporator 101 is introduced into the turbine 102. The turbine 102 converts the energy possessed by the medium introduced in the turbine 102 to rotational energy via an impeller.

The electric generator 103 is connected to the rotation axis of the turbine 102, and converts the rotational energy to electrical energy.

The medium discharged from the turbine 102 is introduced into the condenser 104. The condenser 104 cools and condenses the medium using cooling water.

The hot well tank 105 temporarily stores the medium condensed by the condenser 104.

The pump 106 supplies the condensed medium stored in the hot well tank 105 to the evaporator 101 via the preheater 107.

The preheater 107 heats the medium by utilizing the heat of the fluid discharged from the evaporator 101.

The cooling tower 108 cools the cooling water discharged from the condenser 104. The cooling tower 108 illustrated in FIG. 1 is a spray draft cooling tower. Thus, the cooling tower 108 sprays the cooling water discharged from the condenser 104 in the cooling tower 108, and cools the cooling water by means of induced air.

The pump 109 supplies the cooling water cooled by the cooling tower 108 to the condenser 104.

The components provided in the geothermal electricity generation system 100 are not limited to those illustrated but may be altered as appropriate.

In the geothermal electricity generation system 100, the heat possessed by the fluid extracted via the production well 110 is transferred to the medium via the evaporator 101. The heated medium is evaporated, and expands to rotate the impeller when introduced into the turbine 102. The rotation of the impeller is transferred to the electric generator 103 to generate electricity. On the other hand, the medium discharged from the turbine 102 is condensed by the condenser 104, and is used repeatedly. In the closed loop cycle of the medium, the medium is not released into the air.

Next, the treatment apparatus 1 is illustrated.

A treatment liquid storage unit 2, a supply unit 3, and a control unit 5 (corresponding to an example of a first control unit) are provided in the treatment apparatus 1.

The treatment liquid storage unit 2 stores a treatment liquid 4 containing an acid and an oxidizing substance.

The supply unit 3 supplies the treatment liquid 4 stored in the treatment liquid storage unit 2 to the fluid extracted via the production well 110. The supply unit 3 supplies the treatment liquid 4 stored in the treatment liquid storage unit 2 at least one of between the production well 110 and the evaporator 101, to the evaporator 101, and between the reduction well 111 and the evaporator 101. What is illustrated in FIG. 1 is the case where the treatment liquid 4 is supplied between the production well 110 and the evaporator 101.

The supply unit 3 may be one that can supply the treatment liquid 4 to a high pressure environment. The supply unit 3 may be, for example, a plunger pump or the like.

The control unit 5 controls the supply unit 3 to control the supply amount, supply timing, etc. of the treatment liquid 4.

At this time, the control unit 5 controls the supply unit 3 to control the supply amount of the treatment liquid 4 so that the state of the fluid supplied with the treatment liquid 4 enters region 400 described later. That is, the control unit 5 controls the supply amount of the treatment liquid 4 so that the state of the fluid supplied with the treatment liquid 4 enters a region in the potential-pH diagram where the passivity region of iron, the corrosion region of magnesium, the corrosion region of calcium, and the corrosion region of manganese overlap.

The treatment liquid 4 may be a solution containing an acid and an oxidizing substance. The acid may be, for example, one containing at least one selected from the group consisting of sulfuric acid, nitric acid, phosphoric acid, and hydrochloric acid. As the oxidizing substance, for example, peroxosulfuric acid (e.g. peroxomonosulfuric acid, peroxodisulfuric acid, etc.), peroxonitric acid, peroxophosphoric acid (e.g. peroxomonophosphoric acid, peroxodiphosphoric acid, etc.), hypochlorous acid, and the like may be illustrated. The number of types of the oxidizing substance contained in the treatment liquid 4 may be one, or two or more.

The acid contained in the treatment liquid 4 is added in order to suppress the deposition of components such as magnesium, calcium, and manganese contained in the fluid extracted via the production well 110.

The oxidizing substance contained in the treatment liquid 4 is added in order to suppress the corrosion of components such as the pipes 110a and 111a formed with iron due to the acid contained in the treatment liquid 4 or an acid contained in the fluid extracted via the production well 110.

FIG. 2 is the potential-pH diagram (Pourbaix diagram) of iron.

The region of “Fe” in FIG. 2 is an immunity region (stable region), and is a region where iron can exist stably in water.

The regions of “Fe²⁺”, “Fe³⁺”, and “HFeO₂⁻”in FIG. 2 are corrosion regions, and are regions where iron is corroded in water.

The regions of “Fe₂O₃” and “Fe₃O₄” in FIG. 2 are passivity regions, and are regions where iron becomes passive in water. That is, this is a region where iron is oxidized at the beginning but when a passive film made of iron oxide is formed, corrosion does not proceed any more.

Although the region of “FeO₄²⁻” in FIG. 2 is considered as a region where “FeO₄²⁻” is produced in water, details thereof are not clear up to now. However, this is still a region where iron neither can exist stably nor becomes passive in water.

Therefore, when the state of the fluid is set to be in the immunity region and the passivity region in FIG. 2, the corrosion of components such as the pipes 110a and 111a formed with iron can be suppressed.

Region 300 in FIG. 2 is an iron existence region in water in which sulfuric acid is added (in dilute sulfuric acid). That is, even when only sulfuric acid is added and the concentration (pH value) thereof is controlled, it is difficult for the state of the fluid to enter the passivity region. Thus, when only an acid is added, the deposition of components such as magnesium can be suppressed, but components such as the pipes 110a and 111a formed with iron may be corroded.

Region 310 in FIG. 2 is an iron existence region in water in which an acid and an oxidizing substance are added (in water in which the treatment liquid 4 is added). When an oxidizing substance is added, region 310 can be located above region 300. Although the cause of such a phenomenon is not completely clear, this is considered to be because adding an oxidizing substance makes it easy for a passive film made of iron oxide to be formed. Thus, the state of the fluid can be made to enter the passivity region by supplying the treatment liquid 4 containing an acid and an oxidizing substance.

That is, when the treatment liquid 4 containing an acid and an oxidizing substance is supplied to the fluid extracted via the production well 110, the attachment of a scale can be suppressed and also the corrosion of components formed with iron can be suppressed.

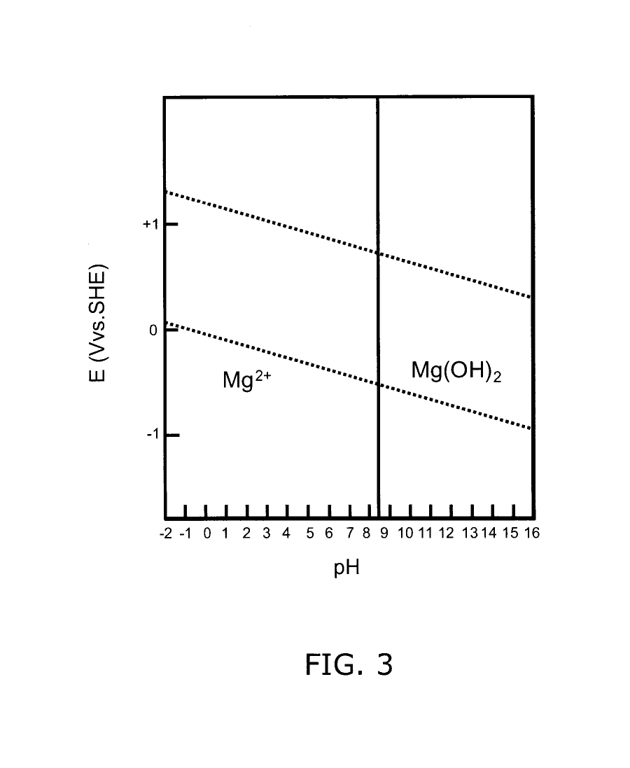

FIG. 3 is the potential-pH diagram of magnesium.

The region of “Mg(OH)₂” in FIG. 3 is a passivity region in which “Mg(OH)₂” is produced in water. That is, this is a region where magnesium dissolved in the fluid extracted via the production well 110 is deposited and a scale will be attached.

The region of “Mg²⁺” in FIG. 3 is a corrosion region where “Mg²⁺” is produced in water. That is, this is a region where magnesium dissolved in the fluid extracted via the production well 110 is not deposited and a scale is not attached.

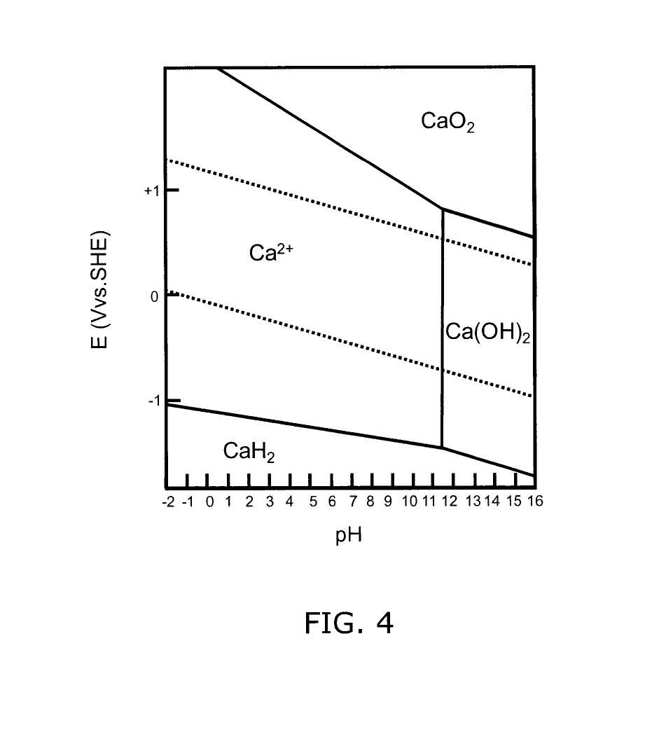

FIG. 4 is the potential-pH diagram of calcium.

The regions of “Ca(OH)₂”, “CaO₂”, and “CaH₂” in FIG. 4 are passivity regions where “Ca(OH)₂”, “CaO₂”, and “CaH₂”, respectively, are produced in water. That is, these are regions where calcium dissolved in the fluid extracted via the production well 110 is deposited and a scale will be attached.

The region of “Ca²⁺” in FIG. 4 is a corrosion region in which “Ca²⁺” is produced in water. That is, this is a region where calcium dissolved in the fluid extracted via the production well 110 is not deposited and a scale is not attached.

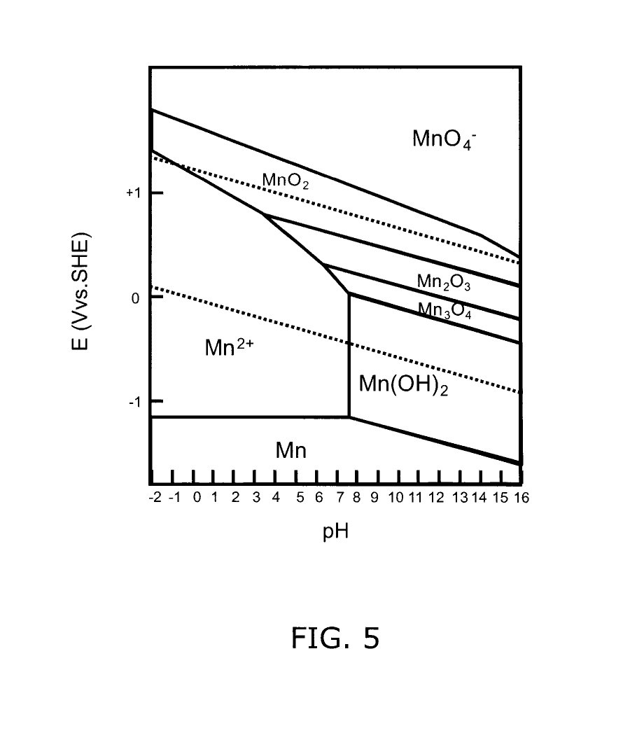

FIG. 5 is the potential-pH diagram of manganese.

The region of “Mn” in FIG. 5 is an immunity region, and is a region where manganese can exist stably in water.

The regions of “Mn(OH)₂”, “MnO₂”, “Mn₂O₃”, and “Mn₃O₄” in FIG. 5 are passivity regions in which “Mn(OH)₂”, “MnO₂”, “Mn₂O₃”, and “Mn₃O₄”, respectively, are produced in water. That is, these are regions where manganese dissolved in the fluid extracted via the production well 110 is deposited and a scale will be attached.

The region of “Mn²⁺” in FIG. 5 is a corrosion region where “Mn²⁺” is produced in water. That is, this is a region where manganese dissolved in the fluid extracted via the production well 110 is not deposited and a scale is not attached.

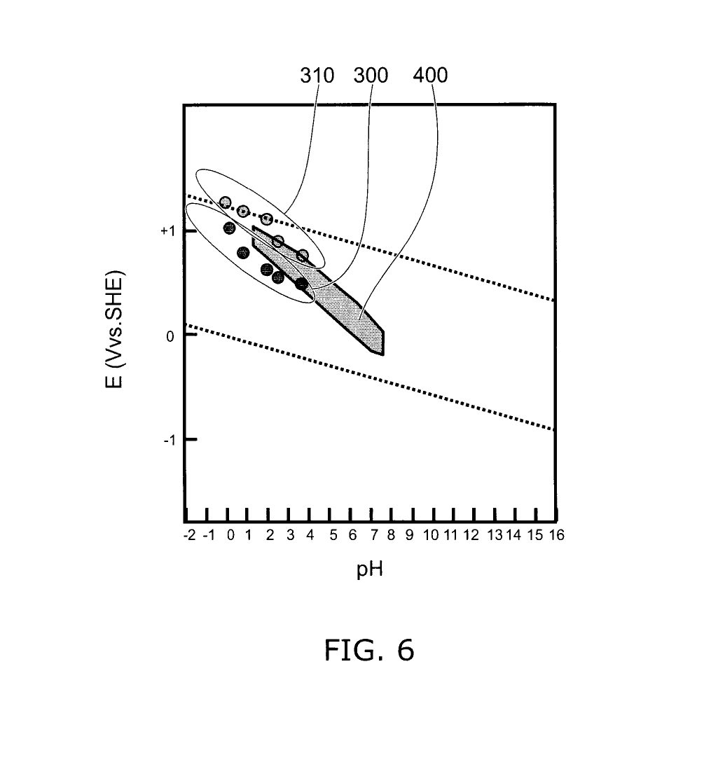

FIG. 6 is the potential-pH diagram for illustrating a region where the corrosion of components formed with iron can be suppressed and also the attachment of a scale can be suppressed.

Region 400 in FIG. 6 is a region where the passivity region of iron in FIG. 2, the region of “Mg²⁺” in FIG. 3, the region of “Ca²⁺” in FIG. 4, and the region of “Mn²⁺” in FIG. 5 overlap. That is, region 400 is a region where the passivity region of iron, the corrosion region of magnesium, the corrosion region of calcium, and the corrosion region of manganese overlap.

In other words, in region 400, the corrosion of components formed with iron can be suppressed and also the attachment of a scale can be suppressed.

Region 300 in FIG. 6 is the iron existence region in water in which sulfuric acid is added (in dilute sulfuric acid), which is illustrated in FIG. 2.

Region 310 in FIG. 6 is the iron existence region in water in which an acid and an oxidizing substance are added (in water in which the treatment liquid 4 is added), which is illustrated in FIG. 2

As can be seen from region 300, when an acid is simply added, it is difficult for the state of the fluid to enter region 400 even when the concentration of the acid (the pH value) is controlled.

As can be seen from region 310, when the treatment liquid 4 containing an acid and an oxidizing substance is supplied, the state of the fluid can be made to enter region 400.

That is, when the treatment liquid 4 containing an acid and an oxidizing substance is supplied to the fluid extracted via the production well 110, the attachment of a scale can be suppressed and also the corrosion of components formed with iron can be suppressed.

There is some variation in the pH value of the fluid extracted via the production well 110. In view of this, the supply amount of the treatment liquid 4 is adjusted in accordance with the pH value of the fluid extracted via the production well 110 so that the state of the fluid enters region 400. There are no particular limitations on the amount of the oxidizing substance contained, and the amount of the oxidizing substance contained may be set to such a value that the state of the fluid enters region 400 with respect to the pH value. An appropriate supply amount of the treatment liquid 4 to a fluid having an arbitrary pH value can be found by making experiment or simulation.

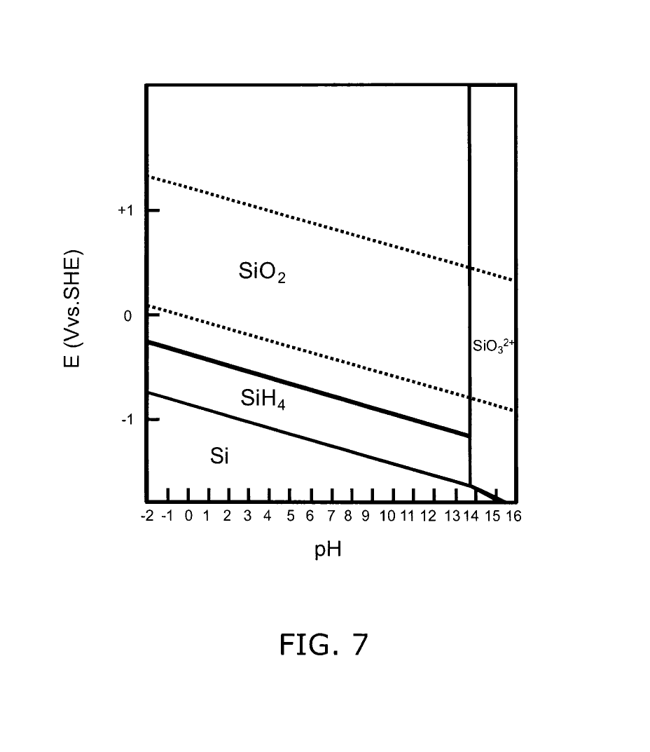

FIG. 7 is the potential-pH diagram of silicon.

The region of “Si” in FIG. 7 is an immunity region, and is a region where silicon can exist stably in water.

The regions of “SiO₂” and “SiH₄” in FIG. 7 are passivity regions where “SiO₂” and “SiH₄”, respectively, are produced in water. That is, these are regions where silicon dissolved in the fluid extracted via the production well 110 is deposited and a scale will be attached.

The region of “SiO₃²⁺” in FIG. 7 is a corrosion region where “SiO₃²⁺” is produced in water. That is, this is a region where silicon dissolved in the fluid extracted via the production well 110 is not deposited and a scale containing silicon is not attached.

As can be seen from FIG. 7, the corrosion region where “SiO₃²⁺” is produced does not overlap with region 400 described above.

Therefore, in the case where silicon is dissolved in the fluid extracted via the production well 110, it is necessary to take a means different from the supply of the treatment liquid 4.

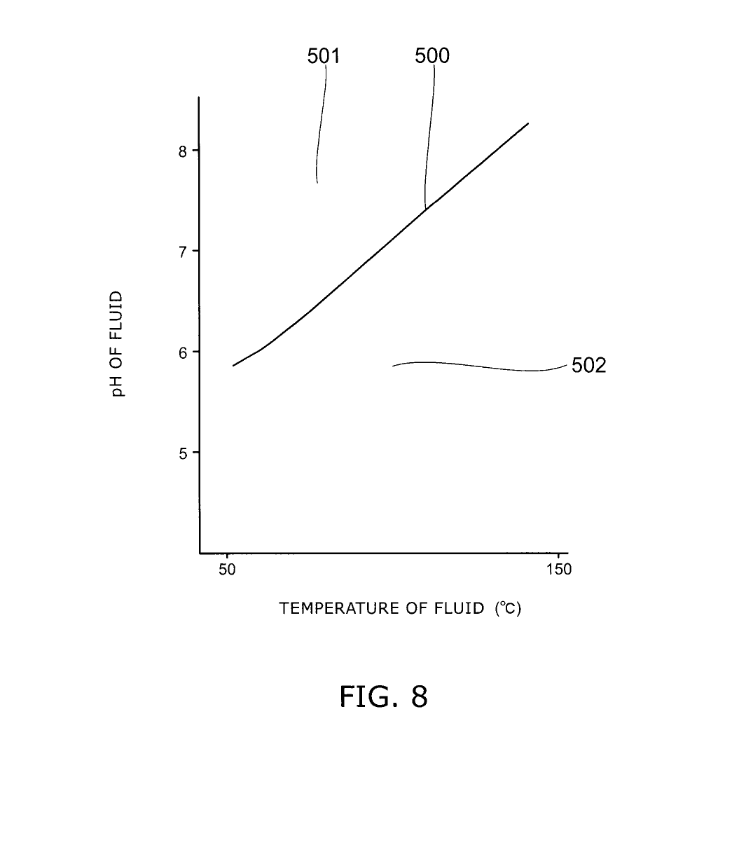

FIG. 8 is a graph for illustrating relationships among the temperature of the fluid, the pH value of the fluid, and the deposition of silicon.

Line 500 in FIG. 8 is a line separating the region where “SiO₂” and “SiH₄” are deposited and the region where the deposition of “SiO₂” and “SiH₄” is suppressed.

In this case, in region 501 formed above line 500, “SiO₂” and “SiH₄” are deposited, and a scale containing silicon will be attached.

In region 502 formed below line 500, the deposition of “SiO₂” and “SiH₄” is suppressed, and the attachment of a scale containing silicon can be suppressed.

That is, in the case where silicon is dissolved in the fluid extracted via the production well 110, the attachment of a scale containing silicon can be suppressed when the relationship between the temperature of the fluid and the pH value of the fluid is appropriately set.

For example, first, the relationships among the pH value of the fluid supplied with the treatment liquid 4, the temperature of the fluid, and the deposition of silicon dissolved in the fluid are found as shown in FIG. 8. Next, at least one of the pH value of the fluid and the temperature of the fluid may be controlled so that silicon dissolved in the fluid is not deposited.

In this case, on the downstream side of the evaporator 101, since the temperature of the fluid is low, a scale containing silicon is likely to be attached. In view of this, for example, the pipe 111a etc. on the downstream side of the evaporator 101 may be kept warm, or the heat taken away by the preheater 107 may be suppressed. Thereby, the attachment of a scale containing silicon can be suppressed.

Thus, by controlling at least one of the supply of the treatment liquid 4, the pH value of the fluid, and the temperature of the fluid, the attachment of a scale containing magnesium, calcium, manganese, silicon, and the like can be suppressed, and also the corrosion of components formed with iron can be suppressed.

As described above, the treatment method according to the embodiment supplies the treatment liquid 4 containing an acid and an oxidizing substance to the fluid extracted via the production well 110. The state of the fluid supplied with the treatment liquid 4 is made to enter a region in the potential-pH diagram where the passivity region of iron, the corrosion region of magnesium, the corrosion region of calcium, and the corrosion region of manganese overlap.

Further, the relationships among the pH value of the fluid supplied with the treatment liquid 4, the temperature of the fluid, and the deposition of silicon dissolved in the fluid are found. At least one of the pH value of the fluid and the temperature of the fluid is controlled so that silicon dissolved in the fluid is not deposited.

The treatment liquid 4 is supplied at least one of between the production well 110 and the evaporator 101, to the evaporator 101, and between the reduction well 111 and the evaporator 101.

The oxidizing substance may be one containing at least one selected from the group consisting of peroxosulfuric acid, peroxonitric acid, peroxophosphoric acid, and hypochlorous acid.

The acid may be one containing at least one selected from the group consisting of sulfuric acid, nitric acid, phosphoric acid, and hydrochloric acid.

### Second Embodiment

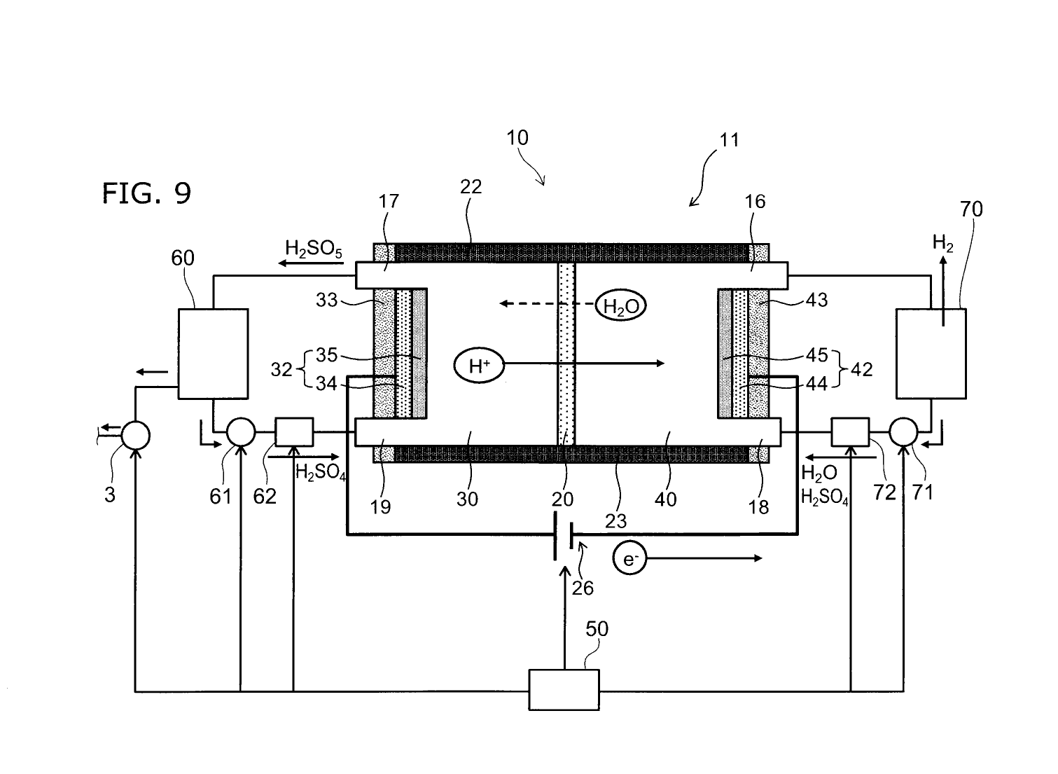

FIG. 9 is a schematic diagram for illustrating a treatment apparatus 10 according to a second embodiment.

The geothermal electricity generation system 100 may be similar to that illustrated in FIG. 1, and a description is omitted.

As shown in FIG. 9, a production unit 11, a control unit 50 (corresponding to an example of a second control unit), a treatment liquid storage unit 60, a pump 61, a temperature control unit 62, a storage unit 70, a pump 71, a temperature control unit 72, the supply unit 3 described above, etc. are provided in the treatment apparatus 10.

The production unit 11 includes an anode 32, a cathode 42, a diaphragm 20 provided between the anode 32 and the cathode 42, an anode chamber 30 provided between the anode 32 and the diaphragm 20, a cathode chamber 40 provided between the cathode 42 and the diaphragm 20, and a DC power source 26 that applies a DC voltage between the anode 32 and the cathode 42.

An upper end sealing unit 22 is provided at the upper ends of the diaphragm 20, the anode chamber 30, and the cathode chamber 40, and a lower end sealing unit 23 is provided at the lower ends of the diaphragm 20, the anode chamber 30, and the cathode chamber 40. The anode 32 and the cathode 42 face each other across the diaphragm 20. The anode 32 is supported by an anode support body 33, and the cathode 42 is supported by a cathode support body 43. The DC power source 26 is connected to the anode 32 and the cathode 42. Although the DC power source 26 is illustrated herein, it is also possible to provide an AC power source and an AC/DC converter. That is, it is sufficient that a power source unit that applies a DC voltage between the anode 32 and the cathode 42 be provided.

The anode 32 is formed of an anode base 34 having electrical conductivity and an anode conductive film 35 formed on the surface of the anode base 34. The anode base 34 is supported by the inner surface of the anode support body 33, and the anode conductive film 35 faces the anode chamber 30.

The cathode 42 is formed of a cathode base 44 having electrical conductivity and a cathode conductive film 45 formed on the surface of the cathode base 44. The cathode base 44 is supported by the inner surface of the cathode support body 43, and the cathode conductive film 45 faces the cathode chamber 40.

An anode inlet port 19 is formed on the lower end side of the anode chamber 30, and an anode outlet port 17 is formed on the upper end side. The anode inlet port 19 and the anode outlet port 17 communicate with the anode chamber 30. A cathode inlet port 18 is formed on the lower end side of the cathode chamber 40, and a cathode outlet port 16 is formed on the upper end side. The cathode inlet port 18 and the cathode outlet port 16 communicate with the cathode chamber 40.

The control unit 50 controls the DC power source 26, the pump 61, the temperature control unit 62, the pump 71, the temperature control unit 72, the supply unit 3, etc.

The treatment liquid storage unit 60 is connected to the anode outlet port 17 via a pipe. The treatment liquid storage unit 60 is connected to the anode inlet port 19 via a pipe, the pump 61, and the temperature control unit 62.

The pump 61 is provided between the treatment liquid storage unit 60 and the anode inlet port 19. The pump 61 circulates a solution containing an acid stored in the treatment liquid storage unit 60 via the temperature control unit 62, the anode chamber 30, and the treatment liquid storage unit 60.

The temperature control unit 62 is provided between the pump 61 and the anode inlet port 19. The temperature control unit 62 controls the temperature of the solution introduced.

In the treatment liquid storage unit 60, a solution containing an acid is stored in the beginning. The solution containing an acid is electrolyzed in the anode chamber 30 to produce an oxidizing substance. Thus, a solution containing an acid and an oxidizing substance is discharged from the anode outlet port 17, and is stored in the treatment liquid storage unit 60. After that, the solution containing an acid and an oxidizing substance stored in the treatment liquid storage unit 60 is circulated via the temperature control unit 62, the anode chamber 30, and the treatment liquid storage unit 60. Thereby, the amount of the oxidizing substance contained can be increased. In this way, the treatment liquid 4 containing an acid and an oxidizing substance is produced.

Details of electrolysis are described later.

Although the temperature of the solution containing an acid is increased when the solution is electrolyzed, the temperature of the solution can be adjusted by the temperature control unit 62.

The treatment liquid storage unit 60 is connected to the supply unit 3 described above via a pipe. The supply unit 3 supplies the treatment liquid 4 stored in the treatment liquid storage unit 60 to the fluid extracted via the production well 110. The supply unit 3 supplies the treatment liquid 4 stored in the treatment liquid storage unit 60 at least between the production well 110 and the evaporator 101, to the evaporator 101, and between the reduction well 111 and the evaporator 101.

The storage unit 70 is connected to the cathode outlet port 16 via a pipe. The storage unit 70 is connected to the cathode inlet port 18 via a pipe, the pump 71, and the temperature control unit 72.

The pump 71 circulates a solution stored in the storage unit 70 via the temperature control unit 72, the cathode chamber 40, and the storage unit 70. The solution stored in the storage unit 70 contains an acid.

The temperature control unit 72 controls the temperature of the solution introduced.

Next, the materials of the components provided in the production unit 11 are illustrated.

For the anode support body 33, the cathode support body 43, the cathode outlet port 16, the anode outlet port 17, the cathode inlet port 18, the anode inlet port 19, the treatment liquid storage unit 60, the storage unit 70, and the pipes through which the solution flows, for example, a material coated with a fluorine-based resin such as polytetrafluoroethylene may be used from the viewpoint of acid resistance. For the sealing at the upper end sealing unit 22 and the lower end sealing unit 23, for example, an O-ring coated with a fluorine-based resin and the like may be used.

As the diaphragm 20, for example, a neutral membrane (which has undergone hydrophilization treatment) including a PTFE porous diaphragm such as Poreflon™ and a cation exchange membrane such as Nafion™, Aciplex™, and Flemion™ may be used. In this case, when a cation exchange membrane is used, an oxidizing substance can be produced in the anode chamber 30 in a state of being separated from the cathode chamber 40.

As the material of the anode base 34, for example, p-type silicon and a valve metal such as titanium and niobium may be used. Here, the valve metal is a metal of which the surface is uniformly covered with an oxide film of that metal by anode oxidization and which has excellent corrosion resistance. For the cathode base 44, for example, n-type silicon may be used.

As the material of the cathode conductive film 45, for example, glassy carbon may be used. Since an acid in a relatively high concentration may be supplied to the anode chamber 30, as the material of the anode conductive film 35, a conductive diamond film doped with boron, phosphorus, or nitrogen is preferably used from the viewpoint of acid resistance. A conductive diamond film may be used also as the material of the cathode conductive film 45. For both the anode side and the cathode side, the conductive film and the base may be formed of the same material. In this case, when glassy carbon is used for the cathode base 44 and when a conductive diamond film is used for the anode base 34, the bases themselves form conductive films having electrode catalytic properties, and can therefore contribute to the electrolysis reaction.

Diamond has chemically, mechanically, and thermally stable properties, but is not good in electrical conductivity and has thus been difficult to use for electrochemical systems.

However, a conductive diamond film is obtained by film-forming while supplying boron gas or nitrogen gas using the hot filament chemical vapor deposition (HF-CVD) method or the plasma CVD method. The conductive diamond film has a wide “potential window” of, for example, 3 to 5 volts and an electric resistance of, for example, 5 to 100 milliohm-centimeters.

Here, the “potential window” is the lowest potential necessary for the electrolysis of water (1.2 volts or more). The “potential window” varies with the material. In the case where a material with a wide “potential window” is used and electrolysis is performed at a potential in the “potential window”, there is also a case where an electrolysis reaction having an oxidation-reduction potential in the “potential window” proceeds preferentially over the electrolysis of water, and an oxidation reaction or a reduction reaction of a substance that is electrolyzed less easily proceeds preferentially. Therefore, using such a conductive diamond film enables the decomposition and synthesis of substances that conventional electrochemical reactions have been unable to do.

In the HF-CVD method, film formation is performed in the following way. First, source gas is decomposed by being supplied to a tungsten filament in a high temperature state, and radicals necessary for film growth are produced. Next, the produced radicals are diffused to the surface of a substrate, and the diffused radicals and another reactive gas are reacted together to perform film formation.

Next, the production of the treatment liquid 4 in the production unit 11 is illustrated.

Herein, the case of producing the treatment liquid 4 containing sulfuric acid and an oxidizing substance (peroxomonosulfuric acid, peroxodisulfuric acid, or the like) is illustrated as an example.

As shown in FIG. 9, a solution containing sulfuric acid is supplied to the anode chamber 30 from the treatment liquid storage unit 60 via the anode inlet port 19.

Sulfuric acid diluted with water is supplied to the cathode chamber 40 from the storage unit 70 via the cathode inlet port 18. In this case, the sulfuric acid concentration of the solution supplied to the cathode chamber 40 is lower than the sulfuric acid concentration of the solution supplied to the anode chamber 30. When a positive voltage is applied to the anode 32 and a negative voltage is applied to the cathode 42, an electrolysis reaction takes place in each of the anode chamber 30 and the cathode chamber 40. In the anode chamber 30, the reactions shown in Reaction Formula 1, Reaction Formula 2, and Reaction Formula 3 take place.

2HSO₄⁻→S₂O₈²⁻+2H⁺+2e⁻ [Reaction Formula 1]

HSO₄⁻+H₂O→HSO₅⁻+2H⁺+2e⁻ [Reaction Formula 2]

2H₂O→4H⁺4e⁻+O₂↑ [Reaction Formula 3]

That is, in the anode chamber 30, a peroxomonosulfate ion (HSO₅⁻) is produced by the reaction of Reaction Formula 2. There is also a reaction in which the full reaction shown in Reaction Formula 4 takes place through the elementary reactions of Reaction Formula 1 and Reaction Formula 3 to produce a peroxomonosulfate ion (HSO₅⁻) and sulfuric acid. When the peroxomonosulfuric acid is contained in the treatment liquid 4 in a prescribed amount or more, the corrosion of components formed with iron (e.g. the pipes 110a and 111a etc.) in the geothermal electricity generation system 100 can be suppressed.

S₂O₈²⁻+H⁺+H₂O→HSO₅⁻+H₂SO₄ [Reaction Formula 4]

Alternatively, there is a case where hydrogen peroxide (H₂O₂) is produced as shown in Reaction Formula 5 from the elementary reactions of Reaction Formula 1 and Reaction Formula 3, and then a peroxomonosulfate ion (HSO₅⁻) of Reaction Formula 4 is produced. There is also a case where peroxodisulfric acid (H₂S₂O₈) is produced by the reaction of Reaction Formula 1. Reaction Formula 4 and Reaction Formula 5 show secondary reactions from Reaction Formula 1.

S₂O₈²⁻+H⁺+H₂O→H₂O₂+H₂SO₄ [Reaction Formula 5]

In the cathode chamber 40, hydrogen gas is produced as shown in Reaction Formula 6. This is because hydrogen ions (H⁺) produced on the anode side move to the cathode side via the diaphragm 20 and an electrolysis reaction takes place. The hydrogen gas is transferred to the storage unit 70 via the cathode outlet port 16, and is extracted to the outside.

2H⁺+2e⁻→H₂↑ [Reaction Formula 6]

In the embodiment, peroxomonosulfuric acid (H₂SO₅) and peroxodisulfuric acid (H₂S₂O₈) can be produced by electrolyzing part of the sulfuric acid contained in the sulfuric acid solution. Although not shown in the reaction formulae described above, also ozone, hydrogen peroxide, etc. are produced as oxidizing substances in addition to peroxomonosulfuric acid (H₂SO₅) and peroxodisulfuric acid (H₂S₂O₈). Therefore, by electrolyzing the sulfuric acid solution, the treatment liquid 4 containing these oxidizing substances and sulfuric acid can be produced as shown in Reaction Formula 7.

H₂SO₄+H₂O→Oxidizing substances+H₂ [Reaction Formula 7]

In this case, when a solution with a high sulfuric acid concentration (e.g. the concentration of sulfuric acid in the solution containing sulfuric acid being 70 percent or more by mass) is supplied to the anode chamber 30 in which an oxidizing substance will be produced, an oxidizing substance can be produced in a condition where there is as little water as possible. Thereby, peroxomonosulfuric acid having the property of reacting with water to be decomposed can be produced stably. Thus, the supply of a fixed amount or a large amount of peroxomonosulfuric acid becomes possible.

In the case where a solution with a low sulfuric acid concentration (e.g. the concentration of sulfuric acid in the solution containing sulfuric acid being 30 percent by mass) is supplied to the anode chamber 30, the handling in the treatment apparatus 10 is easy.

The sulfuric acid concentrations of the solutions supplied to the anode chamber 30 and the cathode chamber 40 are not limited to the concentrations illustrated but may be altered as appropriate.

Here, the production efficiency of peroxomonosulfuric acid is influenced by the sulfuric acid concentration. For example, a SO₃ molecule has a dehydration effect of taking away a H₂O molecule. Therefore, as the amount of SO₃ molecules increases, the ratio of the amount of water molecules that can freely react with other atoms and molecules becomes lower. Thus, in concentrated sulfuric acid, since the decomposition reaction of peroxomonosulfuric acid by water is suppressed, stable production and supply of peroxomonosulfuric acid is possible. For example, peroxomonosulfuric acid can be produced stably when a solution having a sulfuric acid concentration of 70 percent by mass is supplied to the anode chamber 30.

Next, the operation of the treatment apparatus 10 is illustrated.

Herein, the case of producing the treatment liquid 4 containing sulfuric acid and an oxidizing substance (peroxomonosulfuric acid, peroxodisulfuric acid, or the like) in the treatment apparatus 10 is illustrated as an example.

The control unit 50 is used to control the DC power source 26, the pump 61, the temperature control unit 62, the pump 71, the temperature control unit 72, etc. to electrolyze a sulfuric acid solution, and the treatment liquid 4 containing an oxidizing substance (e.g. peroxomonosulfuric acid or peroxodisulfuric acid) and sulfuric acid is produced.

At this time, the production amount of the oxidizing substance (the concentration of oxidizing species) can be controlled by the control unit 50. For example, the DC power source 26 may be controlled by the control unit 50 to change at least one of the current value, the voltage value, and the current passage time; thereby, the production amount of the oxidizing substance can be controlled. Furthermore, for example, the pump 61 may be controlled by the control unit 50 to change the supply amount of the solution containing sulfuric acid and change the number of times of the circulation of the solution; thereby, the production amount of the oxidizing substance can be controlled. Furthermore, for example, the temperature control unit 62 may be controlled by the control unit 50 to change the temperature of the solution; thereby, the production amount of the oxidizing substance can be controlled. In this case, the temperature of the solution is preferably controlled so that the temperature at the time of electrolysis (the temperature when the oxidizing substance is produced) is 40° C. or less.

That is, the control unit 50 controls the production amount of the oxidizing substance by controlling at least one of a power source unit such as the DC power source 26, the pump 61, and the temperature control unit 62.

The process in which sulfuric acid is electrolyzed to produce the treatment liquid 4 containing an oxidizing substance and sulfuric acid is similar to that described above, and a description is omitted.

The produced treatment liquid 4 is stored in the treatment liquid storage unit 60. The treatment liquid 4 stored in the treatment liquid storage unit 60 is supplied to the fluid extracted via the production well 110 by the supply unit 3. At this time, the supply amount, supply timing, etc. of the treatment liquid 4 are controlled by controlling the supply unit 3 by means of the control unit 50.

Here, there is some variation in the pH value of the fluid extracted via the production well 110. In view of this, the supply amount of the treatment liquid 4 is controlled in accordance with the pH value of the fluid extracted via the production well 110. That is, the supply amount of the treatment liquid 4 is controlled in accordance with the pH value of the fluid extracted via the production well 110 so that the state of the fluid enters region 400 described above.

In the treatment apparatus 10 according to the embodiment, the treatment liquid 4 containing an oxidizing substance and sulfuric acid can be produced by electrolyzing sulfuric acid. At this time, the treatment liquid 4 containing an oxidizing substance in a prescribed amount can be produced by controlling the amount of the oxidizing substance produced.

As described above, the treatment method according to the embodiment supplies the treatment liquid 4 containing an acid and an oxidizing substance to the fluid extracted via the production well 110. The state of the fluid supplied with the treatment liquid 4 is made to enter a region in the potential-pH diagram where the passivity region of iron, the corrosion region of magnesium, the corrosion region of calcium, and the corrosion region of manganese overlap.

At this time, an acid is electrolyzed to produce an oxidizing substance to produce the treatment liquid 4.

The relationships among the pH value of the fluid supplied with the treatment liquid 4, the temperature of the fluid, and the deposition of silicon dissolved in the fluid are found. At least one of the pH value of the fluid and the temperature of the fluid is controlled so that silicon dissolved in the fluid is not deposited.

The treatment liquid 4 is supplied at least one of between the production well 110 and the evaporator 101, to the evaporator 101, and between the reduction well 111 and the evaporator 101.

The oxidizing substance may be one containing at least one selected from the group consisting of peroxosulfuric acid, peroxonitric acid, peroxophosphoric acid, and hypochlorous acid.

The acid may be one containing at least one selected from the group consisting of sulfuric acid, nitric acid, phosphoric acid, and hydrochloric acid.

An oxidizing substance can be produced by electrolyzing a solution containing sulfuric acid.

The concentration of sulfuric acid in the solution containing sulfuric acid may be 70 percent or more by mass.

The temperature when the solution containing sulfuric acid is electrolyzed to produce an oxidizing substance may be 40° C. or less.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A treatment apparatus comprising:
a treatment liquid storage unit configured to store a treatment liquid containing an acid and an oxidizing substance; and
a supply unit configured to supply the treatment liquid stored in the treatment liquid storage unit to a fluid extracted via a production well.

2. The apparatus according to claim 1, further comprising a first control unit configured to control the supply unit to control a supply amount of the treatment liquid,
the first control unit being operable to control a supply amount of the treatment liquid so that a state of the fluid supplied with the treatment liquid enters a region in a potential-pH diagram (Pourbaix diagram) where a passivity region of iron, a corrosion region of magnesium, a corrosion region of calcium, and a corrosion region of manganese overlap.

3. The apparatus according to claim 1, further comprising a production unit including:
an anode;
a cathode;
a diaphragm provided between the anode and the cathode;
an anode chamber provided between the anode and the diaphragm;
a cathode chamber provided between the cathode and the diaphragm; and
a power source unit configured to apply a DC voltage between the anode and the cathode.

4. The apparatus according to claim 3, wherein
the treatment liquid storage unit is connected to an anode inlet port and an anode outlet port of the anode chamber,
the apparatus further comprises:
a pump provided between the treatment liquid storage unit and the anode inlet port;
a temperature control unit provided between the pump and the anode inlet port; and
a second control unit configured to control the power source unit, the pump, and the temperature control unit, and
the second control unit controls a production amount of an oxidizing substance by controlling at least one of the power source unit, the pump, and the temperature control unit.

5. The apparatus according to claim 1, wherein the supply unit supplies the treatment liquid at least one of between the production well and an evaporator, to the evaporator, and between a reduction well and the evaporator.

6. The apparatus according to claim 1, wherein the oxidizing substance contains at least one selected from the group consisting of peroxosulfuric acid, peroxonitric acid, peroxophosphoric acid, and hypochlorous acid.

7. The apparatus according to claim 1, wherein the acid contains at least one selected from the group consisting of sulfuric acid, nitric acid, phosphoric acid, and hydrochloric acid.

8. The apparatus according to claim 4, wherein
the pump supplies a solution containing the sulfuric acid to the anode chamber and
the power source unit applies a positive voltage to the anode and applies a negative voltage to the cathode to produce the treatment liquid containing the peroxosulfuric acid and the sulfuric acid.

9. The apparatus according to claim 8, wherein a concentration of the sulfuric acid in a solution containing the sulfuric acid is 70 percent or more by mass.

10. The apparatus according to claim 4, wherein the temperature control unit controls a temperature of a solution containing the sulfuric acid supplied to the anode chamber so that a temperature when the oxidizing substance is produced is 40° C. or less.

11. The apparatus according to claim 4, wherein the pump circulates a solution containing the sulfuric acid via the temperature control unit, the anode chamber, and the treatment liquid storage unit.

12. A treatment method comprising:
supplying a treatment liquid containing an acid and an oxidizing substance to a fluid extracted via a production well; and
making a state of the fluid supplied with the treatment liquid enter a region in a potential-pH diagram where a passivity region of iron, a corrosion region of magnesium, a corrosion region of calcium, and a corrosion region of manganese overlap.

13. The method according to claim 12, wherein the acid is electrolyzed to produce an oxidizing substance to produce the treatment liquid.

14. The method according to claim 12, wherein
relationships among a pH value of the fluid supplied with the treatment liquid, a temperature of the fluid, and deposition of silicon dissolved in the fluid are found and
at least one of the pH value of the fluid and the temperature of the fluid is controlled so that silicon dissolved in the fluid is not deposited.

15. The method according to claim 12, wherein the treatment liquid is supplied at least one of between the production well and an evaporator, to the evaporator, and between a reduction well and the evaporator.

16. The method according to claim 12, wherein the oxidizing substance contains at least one selected from the group consisting of peroxosulfuric acid, peroxonitric acid, peroxophosphoric acid, and hypochlorous acid.

17. The method according to claim 12, wherein the acid contains at least one selected from the group consisting of sulfuric acid, nitric acid, phosphoric acid, and hydrochloric acid.

18. The method according to claim 13, wherein a solution containing the sulfuric acid undergoes the electrolysis to produce the oxidizing substance.

19. The method according to claim 18, wherein a concentration of the sulfuric acid in a solution containing the sulfuric acid is 70 percent or more by mass.

20. The method according to claim 13, wherein a temperature when the oxidizing substance is produced is 40° C. or less.
